(19) United States
(12) Patent Application Publication
(10) Pub. No.: US 2005/0094753 A1
(43) Pub. Date: May 5, 2005

(54) Method and device for setting a filter

(75) Inventor: Stefan Burger, Reinstorf (DE)

Correspondence Address: NIXON & VANDERHYE, PC, 1100 N GLEBE ROAD, 8TH FLOOR, ARLINGTON, VA, 22201-4714, US

(73) Assignee: Matsushita Electric Industrial Co., Ltd., Osaka (JP)

(21) Appl. No.: 10/946,614

(22) Filed: Sep. 22, 2004

(30) Foreign Application Priority Data
Sep. 22, 2003 (DE) 103 44 167.0

(51) Int. Cl. H04L 27/06

(52) U.S. Cl. 375/350

(57) ABSTRACT

The present invention relates to a method and a device for setting an electrical filter comprising a predeterminable number of distributed filter elements, e.g. short-circuited lines, resonators, impedances, etc., exhibiting tolerances, so that the actual filter characteristic curve does not correspond to the theoretical filter characteristic curve, a pulse having a predeterminable centre frequency (f₀) firstly being applied to the filter and then the individual filter elements being tuned on the basis of the impulse response (UA) of the filter. The filter elements are advantageously tuned progressively, starting from the input port (1) of the filter.

The present invention relates to a method for setting a filter, in particular a radio-frequency electrical bandpass filter, comprising a predeterminable number of distributed filter elements, such as short-circuited lines or coupled resonators, according to the preamble of Patent claim 1 and also relates to a device for setting such a filter according to the preamble of Patent claim 8.

In systems appertaining to radio technology, various types of electrical filters are used in order to separate desirable signals from undesirable signals. By way of example, the antenna of a radio receives different signals from various radio stations. In order to receive a desired radio broadcast, the received signals are mixed in a mixer with a signal generated by a tuneable generator. In this case, the frequency that is generated is chosen such that the resulting differential frequency has a defined intermediate frequency. Connected downstream of the mixer is a narrowband bandpass filter that filters out undesirable signals above and below the defined intermediate frequency. What remains is the desired reception signal, which is amplified and demodulated.

Such technical filters are realized in a wide variety of versions. They may comprise inductances and capacitances, (crystal) resonators and resistances, which are principally used at low frequencies up to a few 100 MHz. Parasitic effects occur at higher frequencies, however, so that the components no longer have the desired properties. Filters for higher frequencies are composed of distributed filter elements. These filter elements are for example short-circuited lines or coupled resonators. What is common to all these variants is that the components used exhibit tolerances, so that the resultant filter characteristic curve differs from the ideal, i.e. calculated, filter characteristic curve. Such filters quite generally have to be adjusted in order to obtain the desired attenuation profile.

The filter characteristic curves are generally described in the frequency domain. The attenuation profile from the input to the output of the filter, and the impedance at the input port and at the output port, are defined in a manner dependent on the frequency. When tuning such filters, however, it is found that there is no direct relationship between the individual elements used and the filter characteristic curve. Such filters are tuned manually by specialists who have a great deal of experience, but also cause high costs. These specialists tune the filters according to a few basic rules and intuitive aspects.

Moreover, methods are known (Computing aided Diagnosis and Tuning of Cascaded Coupled Resonators Filter; Heng-Tung Hsu, Hui-Wen Yao, Kawathar A. Zaki, Ali E. Atia; MTT Vol. 50, No. 4, April 2002, pp. 1137-1145), according to which filters are tuned automatically.

However, these methods comprise an iterative tuning of individual filter elements which are shifted often, so that they are damaged in the process and are often no longer useable.

Therefore, the present invention is based on the object of specifying a method and a device for setting an electrical filter which proceeds automatically, i.e. without human assistance, and which tunes filters, so that the ideal filter characteristic curve is achieved.

The present invention achieves the object on which it is based by means of the characterizing features of the independent Patent claims 1 and 8. Advantageous refinements of the invention emerge from the subclaims.

If a pulse is applied to a filter in the time domain, then it is possible to measure the characteristic impulse response of said filter at the fed-in port. The present invention is based on the insight that a direct relationship exists between the centre frequency of the pulse and the centre frequency of the filter. Consequently, there is a direct relationship between the individual elements of the filter and the impulse response. The invention makes use of this insight, so that a filter comprising a predeterminable number of distributed filter elements exhibiting tolerances such that the actual filter characteristic curve does not correspond to the theoretical filter characteristic curve is tuned in such a way that a pulse having a predeterminable centre frequency is first of all applied to the filter and the filter elements can be individually tuned on the basis of the impulse response of the filter.

The filter elements are advantageously tuned progressively, i.e. starting from the input port of the filter. In this case, the input port is generally the port to which the pulse is applied.

The predeterminable centre frequency of the pulse advantageously corresponds to the centre frequency of the tuned, i.e. ideal, filter. The individual filter elements are tuned on the basis of the minima of the impulse response or the phase of the signal reflected at the input port, or by means of both criteria. In this case, the filter is essentially tuned in three successive steps according to the invention:

If a filter is to be designed, then, in a first step, by way of example, the values for an LC low-pass filter are calculated and transformed in a known manner into a bandpass filter. A further fine optimization of these values may be performed on the basis of a circuit simulator. The circuit simulator supplies the properties of the filter in the frequency domain. The filter characteristic curve can also be calculated from the transfer equation. In a second step, the impulse response of the filter in the time domain is then obtained on the basis of an inverse Fourier transformation. The required nature of the reflected signal of each individual filter element of the filter in the time domain is known on the basis of the now known impulse response. The ideally reflected signal of each filter element is thus defined in the time domain in a manner dependent on the impulse response.

In a third step, the individual filter elements are then altered progressively, starting from the input port of the filter, on the basis of the ideal reflected signal until it has the value of the ideal reflected signal. The same value as in the case of the ideal filter has to be achieved in the case of the couplings. The resonant frequency of resonators, for example, is tuned to the minimum of the impulse response in the time domain.

The direction in which tuning has to be effected results from the phase profile of the impulse response. If a change from the higher phase value to the lower phase value can be seen in the phase profile, then the resonant frequency of the resonator is too low. If a profile from the low value to the higher value can be seen, the resonant frequency is too high.

Since the adjacent elements are also influenced by the process of tuning the individual elements, tuning is advantageously effected anew after each tuning process starting from the fed-in port (input port). In this case, it is possible to take account of the influence of an incorrect coupling on the downstream elements. If the coupling is too great, more energy is conducted to the downstream parts of the filter, so that the reflected signal appears larger than in the case of an ideal coupling factor, and vice versa.

According to a further embodiment, to a first approximation, this influence of a greater coupling may, however, also be calculated and the downstream elements may be tuned in the same work step.

The device according to the invention for setting an electrical filter has pulse means that apply a pulse having a predeterminable centre frequency to the filter, and also measuring means that measure the impulse response of the filter and tune the individual filter elements on the basis of the impulse response.

The circuit simulator for defining the filter attenuation serves for fine optimization. On the basis of the properties of the filter in the frequency domain, it is possible to determine the impulse response in the time domain by means of a transformer that carries out an inverse Fourier transformation.

If the filters are constructed from LC resonators, then it is possible e.g. for the capacitor to have connected in parallel with it a trimming capacitor having a significantly smaller value than the fixed capacitor. The resonant frequency of the resonator is altered by altering the trimming capacitor. The coupling between the inductances can be altered by the distance from one another. If the two coils are coupled by means of a common ferrite core, then the coupling can be set by rotating the core in and out.

A preferred exemplary embodiment of the present invention is explained in more detail below with reference to the drawings, in which:

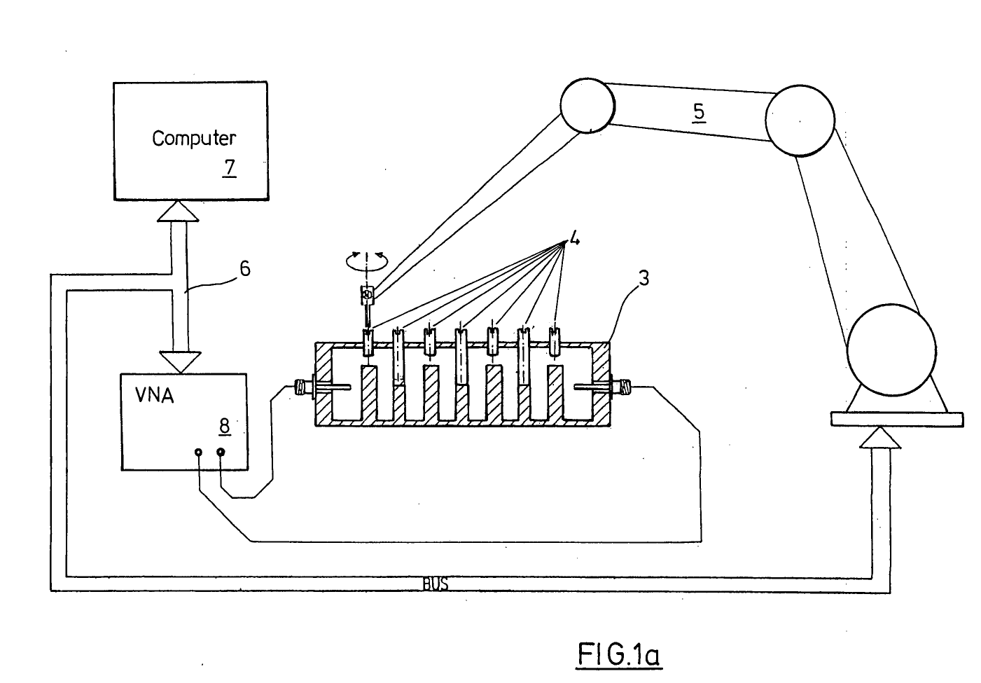

FIG. 1 shows the schematic circuit arrangement of a conventional bandpass filter,

FIG. 1a shows the schematic arrangement of an automatically tuneable combline bandpass filter,

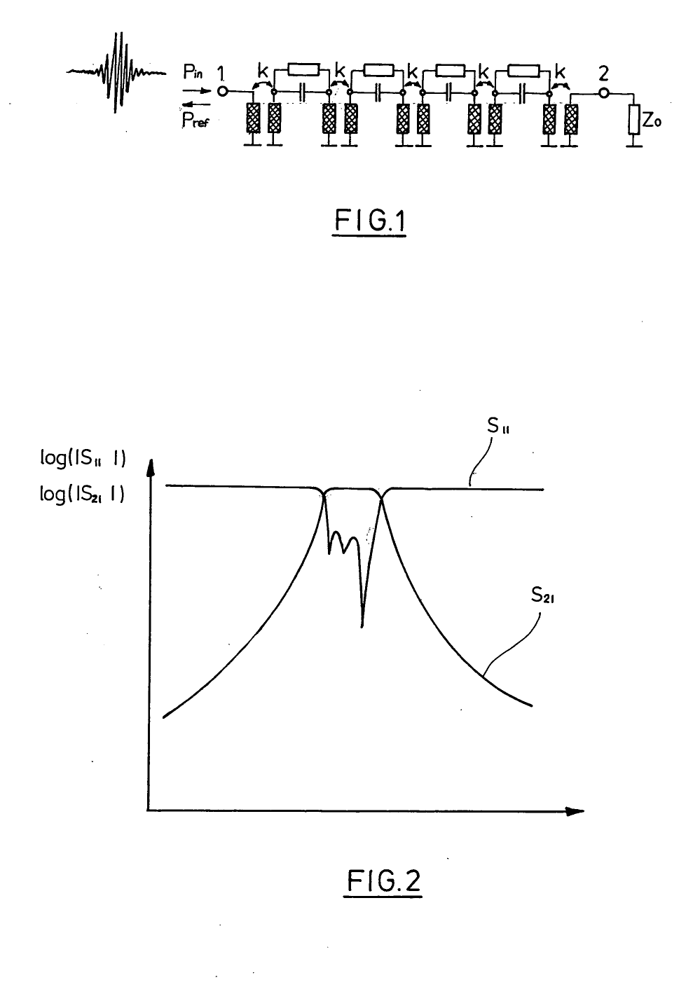

FIG. 2 shows the filter characteristic curve of a detuned filter,

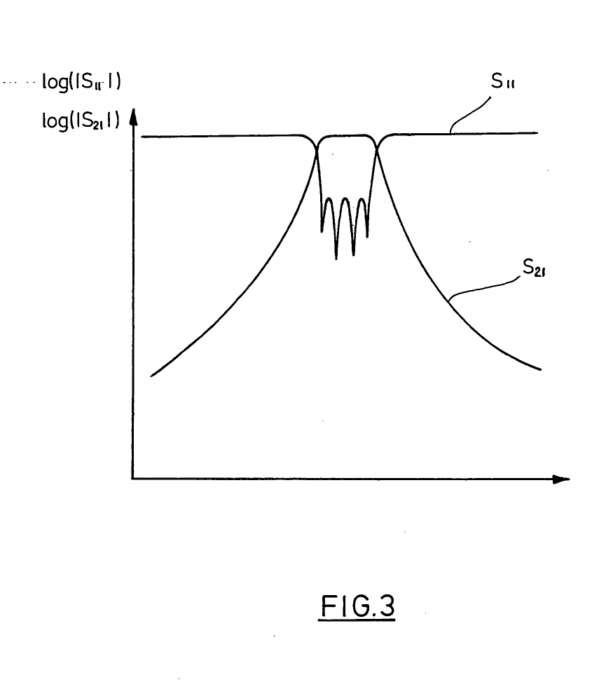

FIG. 3 shows the filter characteristic curve of a tuned filter, and

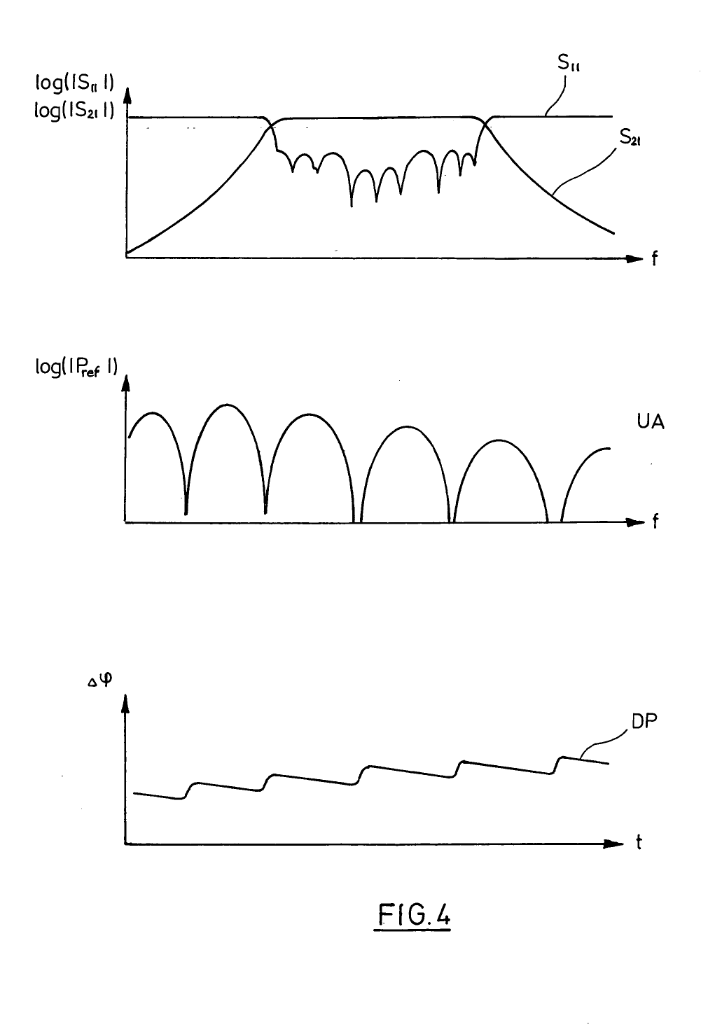

FIG. 4 shows the filter characteristic curve, impulse response and delta phase of a detuned filter.

The present invention is explained in more detail using the example of a combline bandpass filter with reference to FIGS. 1 to 4:

FIG. 1 shows the schematic circuit arrangement of a conventional bandpass filter comprising coupled LC resonators with resistors connected in parallel for the losses. If a pulse is applied to this bandpass filter at its input port 1, then this leads to a corresponding impulse response at the input port 1. At relatively high frequencies, the filter elements shown in FIG. 1 are replaced by coaxial lines that are coupled to one another, as in the case of the combline bandpass filter. These coaxial lines generally have a length of approximately ⅛ of the wavelength. The lines are short-circuited at one end and open at the other end. In order that no energy is emitted at the open end, the line is short-circuited at a short distance.

As illustrated in FIG. 1a, the resonant frequency of the combline resonator can be detuned by means of screws 4 above the open-circuited internal conductor. The coupling can be set by means of the tuning screws in the screen opening. In this case, FIG. 1a shows the combline bandpass filter 3 with four coupled resonators each provided with tuning elements 4. By means of a data bus 6, the tuning can be effected automatically at the tuning elements by means of a robot 5. The signals, i.e. the control instructions for driving the robot 5, are calculated by means of a control computer 7 that reads a vectorial network analyser 8.

The individual lines are coupled to one another by means of screens between the coaxial lines. The individual lines behave like parallel resonant circuits as long as they are considered in the vicinity of the resonant frequency. Energy is fed in at the port 1, and is measured at the port 2. The centre frequency f₀ is assumed to be a frequency of 2.14 GHz. In this transmission band, the energy fed in is forwarded to the output port 2 almost without any losses.

If the filter is detuned, then the filter characteristic curve S11 shown in FIG. 2 results given an assumed ideal attenuation. If an attempt is then made to tune the filter, it will be ascertained that there is a direct relationship between the profile of the impulse response UA illustrated in FIG. 4 and the individual elements of the filter. By contrast, there is no direct relationship between the profile of the filter characteristic curve S11 and the individual filter elements.

FIG. 4 shows the impulse response of the filter that is not ideally tuned.

If the phase DP of the reflected signal is considered, then it may be ascertained that said phase rises with increasing time. If the linear component is subtracted, then a steep jump may be ascertained at the place of the dips. If the resonator, i.e. the corresponding filter element, is not tuned exactly, then, on the one hand, the minimum of the impulse response UA is not attained and, on the other hand, the jump in the phase DP becomes a ramp. It can be discerned on the basis of this profile whether the resonant frequency of the resonator is set too high or too low.

1. Method for setting a filter comprising a predeterminable number of distributed filter elements exhibiting tolerances, so that the actual filter characteristic curve does not correspond to the theoretical filter characteristic curve,
characterized
in that a pulse having a predeterminable centre frequency (f₀) is applied to the filter, and in that the individual filter elements are tuned on the basis of the impulse response (UA) of the filter.

2. Method according to claim 1,
characterized
in that a pulse having a predeterminable centre frequency (f₀) is applied to both the filter and the theoretical filter characteristic curve, and in that the calculated impulse response of the theoretical filter characteristic curve is used as a tuning model for the filter according to magnitude and phase.

3. Method according to claim 1,
characterized
in that the predeterminable centre frequency (f₀) corresponds to the centre frequency of the tuned filter, and in that the individual filter elements are tuned on the basis of the minima of the impulse response (UA) and/or the phase (DP) of the signal reflected at the input port.

4. Method according to claim 1,
characterized
in that the filter elements are tuned progressively, starting from the input port (1) of the filter.

5. Method according to claim 1,
characterized
in that, in a first step, the impulse response (UA) is determined by means of an inverse Fourier transformation of the filter attenuation, in that, in a second step, the ideal reflected signal of each filter element is determined in the time domain depending on the impulse response (UA), and in that, in a third step, the individual filter elements are altered progressively, starting from the input port of the filter, on the basis of the ideal reflected signal until it has the value of the ideal reflected signal.

6. Method according to claim 1,
characterized
in that the tuning direction is determined on the basis of the phase profile (DP).

7. Method according to claim 1,
characterized
in that, after the tuning of one filter element, the further filter elements are tuned anew, starting from the input port of the filter.

8. Device for setting a filter comprising a predeterminable number of distributed filter elements exhibiting tolerances, so that the actual filter characteristic curve does not correspond to the theoretical filter characteristic curve,
characterized
in that pulse means apply a pulse having a predeterminable centre frequency (f₀) to the filter,
in that measuring means measure the impulse response (UA) of the filter, and
in that the individual filter elements can be tuned on the basis of the impulse response (UA) of the filter.

9. Device according to claim 8,
characterized
in that a circuit simulator serves for defining the filter attenuation, and in that, by means of a transformer, it is possible to determine the impulse response (UA) by means of the filter attenuation.
